(19) United States
(12) Patent Application Publication
(10) Pub. No.: US 2013/0019984 A1
(43) Pub. Date: Jan. 24, 2013

(54) Pipe Pitch Article, System and Method of Installation

(71) Applicants: ERIC ALLENDORF, WEST HAVEN, CT (US); JOHN POPLAWSKI, MERIDAN, CT (US)

(72) Inventors: ERIC ALLENDORF, WEST HAVEN, CT (US); JOHN POPLAWSKI, MERIDAN, CT (US)

(73) Assignee: THE MISDUN GROUP, INC., Southington, CT (US)

(21) Appl. No.: 13/185,686

(22) Filed: Jul. 19, 2011

(51) Int. Cl. F16L 55/00

(52) U.S. Cl. 138/103; 29/428

(57) ABSTRACT

An article, system and method of installation of a pipe in fixed association with at least one stanchion, said stanchion having a mount for fixing the stanchion to a mounting surface, said length of stanchion serving to establish a fixed distance between the pipe relative to the mounting surface, such that when the pipe is mounted thereon the surface, a pitch of the pipe in the direction of the sink and away from the source of a liquid insures the proper rate of gravitational flow of the liquid therein.

### FIELD OF THE INVENTION

This application relates generally to pipes employed in installations in buildings and other facilities that utilize piping systems for the transport of liquids.

### BACKGROUND OF THE INVENTION

This invention provides an article, system and an installation method to insure that the proper pitch is employed in piping systems for the transport of liquids, typically constructed from plastic formulated pipes, such as a polyvinylchloride (PVC) and used in homes, offices and other facilities, generally. Although potable water and waste water, are the most frequent substance transported other fluids such as natural gas and gasoline are transported from one location to another via complex networks of pipes. These networks of pipes typically include long, relatively straight lines that enter into and exit from enclosed spaces, with occasionally intersected branches, and that may additionally bend around various enclosure walls and support structures, making it difficult to maintain a decreasing elevation as the piping progresses over its intended route. One problem with the use of piping systems is to insure that the pitch is in the direction of the sink and away from the source to insure the proper rate of flow and that liquid does not stagnate or worse, have impeded flow because pipes are pitched in the wrong direction. Presently there does not exist any device that insures a fool-proof means to install piping, especially in a rapid production fashion, that guarantees that the piping system is pitched properly, can be installed properly by a relatively unskilled work-force and is virtually no more expensive than the product without such advantages. With the foregoing in mind, the present invention will be distinguished over the prior art in the description and application of new components, design criteria and utility to the field of the invention.

### SUMMARY OF THE INVENTION

This invention provides a novel pipe in fixed association with at least one stanchion and its related elements. The stanchion attaches at one end either directly to a pipe or through a boss attached to a pipe, the manner and method of attachment is not an essential consideration, and at its other end to a mount that affixes the assembly to a mounting surface. The length of stanchion, including the mount and any boss if employed, serves to establish a fixed distance between the pipe relative to the mounting surface, such that when the pipe is mounted as an element of a piping system, a pitch of the piping system is provided in the direction of the sink and away from the source of a liquid to insure the proper rate of gravitational flow. In what follows, when the dimension of the stanchion is referred to, it is meant to include the added dimensions of the boss if used and the mount, which is a needed component.

This invention also relates to a system for pipe installation including one or more pipes, each of which pipe is in fixed association with two or more stanchions, said stanchions having a mount for affixing the mount to a mounting surface, each said individual length of a stanchion serving to establish an increasing distance between the pipe relative to the mounting surface when fixed to the pipe along its length, such that when the pipe is mounted as an element of a piping system, it provides a pitch of the one or more pipes in the piping system in the direction of the sink and away from the source of a liquid to insure the proper rate of gravitational flow.

The stanchion included herein is one of, a vertical pole, rod, an upright bar, beam, post, or plate, used to support and fix a pipe to a surface. The surface referred to is generally horizontally positioned, however in certain limited applications the surface may be vertically position, as described below, especially in connection with the mounting of the embodiment illustrated in FIG. 1c and FIG. 1d.

The invention herein further refers to a method for pipe installation including, mounting one or more pipes each said pipe in fixed association with a two or more stanchions, said stanchions having a mount for affixing it to a mounting surface, each said individual length of a stanchion (including the mount) serving to establish an increasing distance between the pipe relative to the mounting surface, in a piping system to provide a pitch of the one or more pipes in the direction of the sink and away from the source of a liquid to insure the proper rate of gravitational flow.

### BRIEF DESCRIPTION OF THE DRAWINGS

This invention is best understood from the following detailed description when read in connection with the accompanying drawing. The various features of the drawing are not specified exhaustively. On the contrary, the various features may be arbitrarily expanded or reduced for clarity. Included in the drawing are the following figures:

FIG. 1 (a, b, c, d) illustrates the pipe pitch article in accordance with one embodiment of the present invention.

FIG. 2 (a, b) illustrates the pipe pitch article and system in accordance with one embodiment of the present invention.

FIG. 3 (a, b) illustrates the pipe pitch article in accordance with alternate embodiments of the present invention.

### DETAILED DESCRIPTION OF THE INVENTION

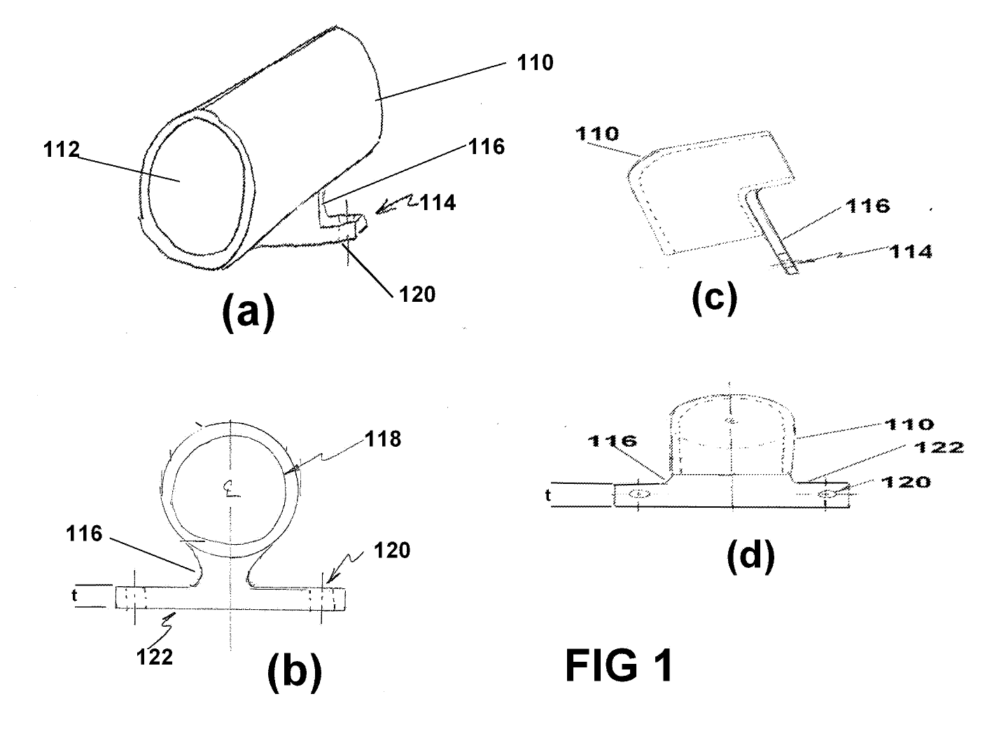

FIG. 1a shows a perspective view and FIG. 1b an end-view of one embodiment of the pitched pipe, which includes a pipe 110 having a through-opening 112 where a liquid flows contacting the inner surface 118 of the pipe 110. The pipe 110 is in a fixed association with at least one stanchion 116, the stanchion having an integrally attached mount 114 for affixing the mount 114 to a mounting surface utilizing a fastener, such as a nail or screw, and through-hole 120. As mentioned in dimensioning the distance from the pipe to the mounting surface, the thickness of the mount “t” is considered.

FIG. 1c shows a perspective view and FIG. 1d an end-view of one embodiment of the pitched pipe utilized for creating a bend is a piping system. This figure also depicts a vertical mounted pipe 110. The pipe 110 is in a fixed association with at least one stanchion 116, the stanchion having a mount 114 for affixing the mount 114 to a mounting surface. In dimensioning the distance from the pipe in the case of a vertical mount, the thickness of the mount “t” is not relevant to establishing the pitch dimension.

The pipes of this invention may be represented by a through-pipe that may be inserted into a female portion of a union to achieve longer length or pipe runs. The pipes as the term is used in reference to this invention also may be represented by the union itself, i.e., the pipe-section having a female portion to accept longer pipes having smaller diameters than the receptacle into which it fits. Furthermore, the invention includes in the definition of pipe, such as by way of example and not limitation, a through pipe-section, a nipple, an insert, a union, a bulkhead fitting, a conduit, or valve. Those of ordinary skill in the art of plumbing are familiar with the different styles, products and uses of the various types of piping.

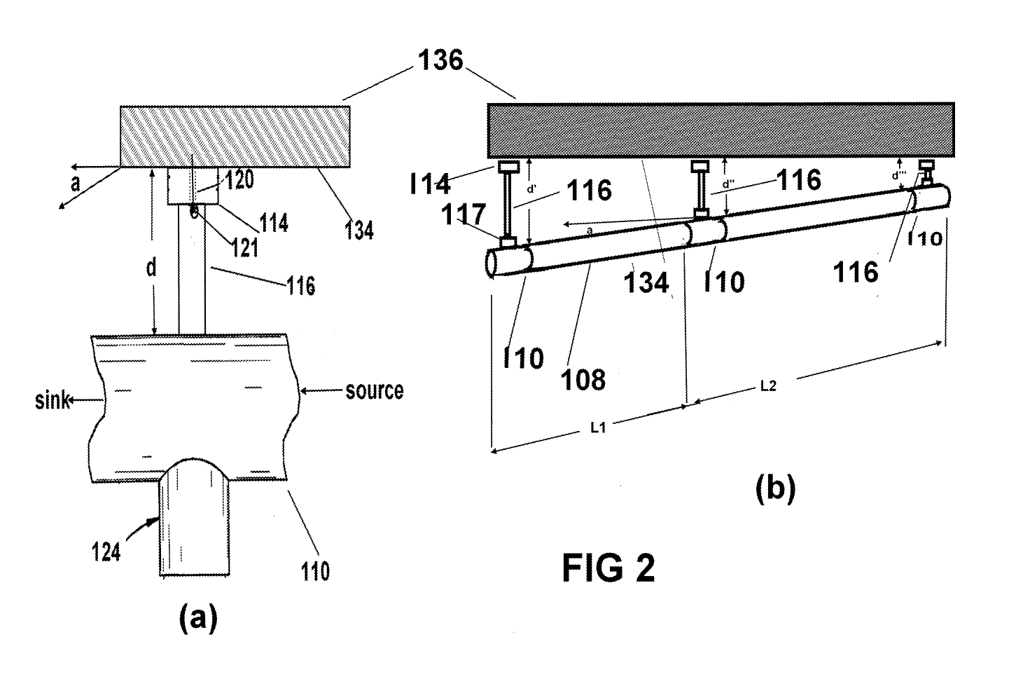

FIG. 2a shows the pipe 110 in fixed association with at least one stanchion 116, the stanchion having a mount 114 for affixing the mount 114 to a mounting surface 134 associated with the structure 136 of a building. The length of stanchion 116 and its associated mount and boss, if included, serves to establish a distance “d” between the pipe 110 relative to the mounting surface 134. Each related pipe 110 used in a series of piping, creates a piping system as shown in FIG. 2b, and has increasing stanchion distances “d”, such as d′, d″ and d′”. Note that the pipes 110 illustrated in FIG. 2a are by way of example and not limitation, designed as unions that accept the longer pipes 108. As will be apparent, the stanchions, as referred to herein, depending on design choice are capable of being an integral part of the longer pipe 108.

Still referring to FIG. 2a, when two or more of the pipe 110 are mounted, as by way of example as shown in FIG. 2b, a pitch “a” of the pipe 110 in the piping system relative to the mounting surface 134 is achieved in the direction of the sink and away from the source of a liquid insures the proper rate of gravitational flow.

Referring again to FIG. 2b, the invention relates to a system for pipe installation including one or more pipes 110, each of which pipe length “L₁” and “L₂” is in fixed association with two or more stanchions, each stanchion having a mount 114 for affixing the mount to the mounting surface 134. Each length “d,” which includes the stanchion with the mount and any boss, serves to establish an increasing distance between the pipes relative to the mounting surface 134, when fixed to a pipe along its length resulting in a downward pitch “a.”

In one non limiting embodiment of the system, a desired pitch, such as pitch “a” of the pipe system in FIG. 2b, is one-eighth inch per foot, along a relatively horizontal mounting surface 134. By way of example, a pipe run supported along pipe length “L₁” and “L₂” at four-foot intervals by a series of pipes 110 having increasing dimensions “d” of one-half inch every four feet will establish a one-eighth inch per foot pitch “a” along a relatively horizontal mounting surface. In on embodiment of the system, the pitch “a” satisfied by one or more pipes 110 having increasing dimension “d” such as substantially: ½ inches, 1½ inches, 2 inches, 2½ inches, 3 inches, 3½ inches, 4 inches, 4½ inches, etc.

The stanchion 116 included by way of example and not limitation may be embodied alternatively as one of, a vertical pole, rod, an upright bar, beam, post, or plate, used to support and fix a pipe to a surface. As such the stanchion may be provided in varying fixed lengths, each fastened rigidly to a mount 114. Referring to FIG. 2b, as previously mentioned, stanchion 116 length and mount 114 thickness “t” comprise the total length of the distance “d” between a mounting surface and the pipe 110. If a boss 117 is employed to affix the stanchion to the pipe it will be additive to the stanchion and contribute to the total distance “d” between the pipe and the mounting surface 134.

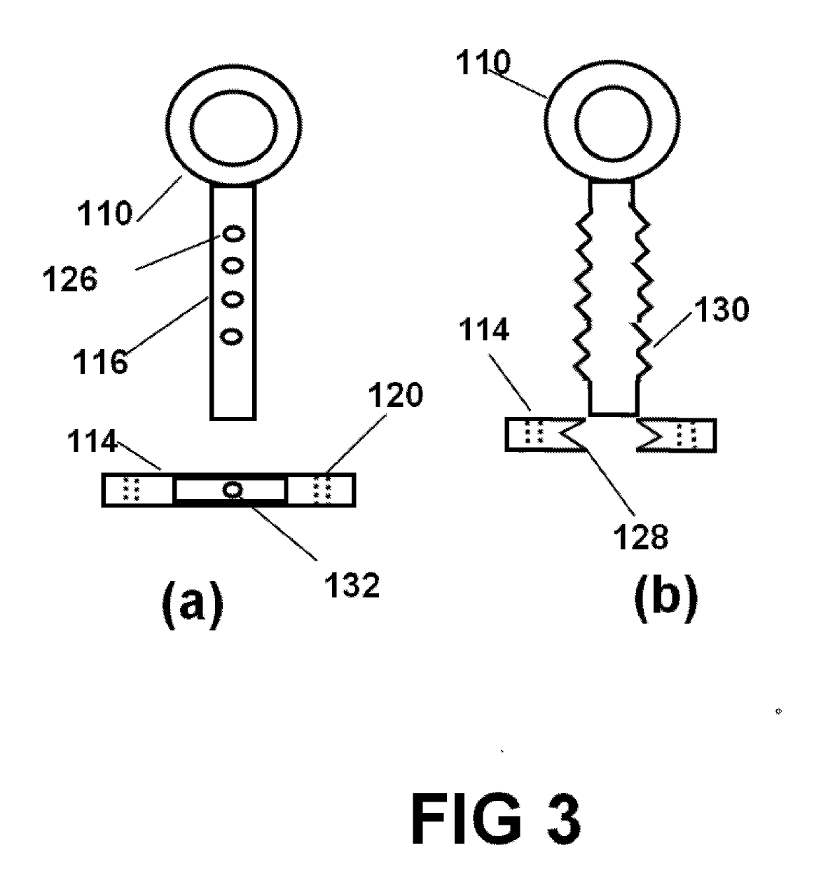

In two alternate embodiments shown in FIGS. 3a, b, distance “d” is established by utilizing a stanchion attached to the body of the pipe 110 (also, as shown in FIG. 1a, FIG. 1b), but with a separate mount 114. The mount 114 is then adjusted to the proper height by moving it onto the stanchion vertically and fixing its position thereon. In FIG. 3a, the mount 114 associates with the stanchion, as by way of example and not limitation, sliding it onto the stanchion, where it is fastened by a screw or other such appropriate fastener matching the through-hole 132 to a hole on 126 on the stanchion. In FIG. 3b the mount is a nut-like device that screws onto the stanchion threads 130 and is fixed in place thorough an appropriate nut design or suitable chemical bond. Once the mount 114 is in position, then any excess stanchion material must be removed before the mount is affixed to the horizontal mounting surface 134. Other designs will be apparent to those of a person of ordinary skill in the art of mechanical mounting devices.

The pipe 110 article of the invention including its component parts, such as the stanchion, boss, and mount, may be manufactured, by way of example and not limitation, from one of: polyvinyl chloride PVC, chlorinated polyvinyl chloride CPVC, cast iron, or copper, having sizes of the pipe referred to in the plumbing industry as Schedule 40 or Schedule 80, among other sizes as may exist in other industries.

Referring again to FIG. 2b, the invention also refers to a method for pipe installation including, mounting one or more pipes 110 each said in fixed association with a two or more stanchions 116, said stanchions 116 having a mount 114 for affixing the mount to a mounting surface 136, each said individual length of a stanchion and included thicknesses of the mount 114 and/or boss 117, serving to establish an increasing distance between the pipe along pipe length “L₁” and “L₂” relative to the mounting surface, providing a pitch “a” along pipe length “L₁” and “L₂” of the pipes in the direction of the sink and away from the source of a liquid to insure the proper rate of gravitational flow. By way of example and not limitation, the method for pipe installation therefore includes a pipe run supported by stanchions at intervals by a series of pipes having increasing dimensions “d” dependent on the interval length. The stanchion and the associated mount vary the distance “d” of the pipe as illustrated in FIG. 2b.

While the present invention has been described with reference to the illustrative embodiments, this description is not intended to be construed in a limiting sense. Various modifications of the illustrative embodiments, as well as other embodiments of the invention, will be apparent to those skilled in the art in reference to this description. It is expressly intended that all combinations of those elements that perform substantially the same function in substantially the same way to achieve the same results are within the scope of the invention. Substitutions of elements from one described embodiment to another are also fully intended and contemplated. It is therefore contemplated that the appended claims will cover any such modifications or embodiments as fall within the true scope of the invention.

We claim:

1. An article of manufacture comprising: a pipe in fixed association with at least one stanchion, said stanchion having a mount for fixing the stanchion to a mounting surface, said length dimension “d” of stanchion and associated mount serving to fix a distance between the pipe relative to the mounting surface, such that when the pipe is mounted therein a pitch is provided in a piping system in the direction of the sink and away from the source of a liquid to insure the proper rate of gravitational flow.

2. The article of claim 1, wherein the stanchion is one of, a vertical pole, rod, an upright bar, beam, post, or plate, used to support and fix a pipe to a surface.

3. The article of claim 1, wherein the dimension “d” is one of substantially: ½ inches, 1½ inches, 2 inches, 2½ inches, 3 inches, 3½ inches, 4 inches, 4½ inches.

4. The article of claim 1, wherein the material of manufacture is one of: polyvinyl chloride PVC, chlorinated polyvinyl chloride CPVC, cast iron, or copper.

5. The article of claim 1, wherein the size of the pipe is one of: Schedule 40 or Schedule 80.

6. The article of claim 1, wherein the pipe includes one of: a through pipe-section, a nipple, an insert, a union, a bulkhead fitting, a conduit, or valve.

7. The article of claim 1, wherein the stanchion and the mount combine to vary the distance “d” of the pipe.

8. A system for pipe installation comprising: one or more pipes, each of which pipe is in fixed association with two or more stanchions, said stanchions fixed to a mounting surface, each said individual length of dimension “d” of a stanchion serving to establish an increasing distance between the pipe relative to the mounting surface, when fixed to the pipe along the length of a piping system, providing a pitch of the one or more pipes of a piping system in the direction of the sink and away from the source of a liquid to insure the proper rate of gravitational flow.

9. The system in claim 8, wherein each said stanchion of the two or more stanchions is one of, a vertical pole, rod, an upright bar, beam, post, or plate, used to support and fix a pipe to a surface.

10. The system in claim 8, wherein the mounting surface is one of a horizontal or vertically position relative to the pipe.

11. The system in claim 8, wherein a pipe run is supported at four-foot intervals by a pipes having increasing dimensions “d” of ½ inch every four feet.

12. A method for pipe installation in a piping system comprising: mounting one or more pipes each of said pipe in fixed association with a two or more stanchions, said stanchions having a mount; affixing the mount to a mounting surface, each said individual length dimension “d” of a stanchion serving to establish an increasing distance between the pipe relative to the mounting surface to provide a pitch of the piping system, in the direction of the sink and away from the source of a liquid to insure the proper rate of gravitational flow.

13. The method for pipe installation in claim 12, wherein the stanchion is one of, a vertical pole, rod, an upright bar, beam, post, or plate, used to support and fix a pipe to a surface.

14. The method for pipe installation in claim 12, wherein a pipe run is supported at intervals by a series of pipes having increasing dimensions “d” dependent on the interval length.

15. The method for pipe installation in claim 12, wherein the pipe includes one of: a through pipe-section, a nipple, an insert, a union, a bulkhead fitting, a conduit, or valve.

16. The method for pipe installation in claim 12, wherein the stanchion and the mount associate to vary the distance “d” of the pipe.
